(19) United States
(12) Patent Application Publication
(10) Pub. No.: US 2022/0015569 A1
(43) Pub. Date: Jan. 20, 2022

(54) DUTCH OVENS HAVING LIDS WITH INTEGRAL GRIDDLES

(71) Applicant: Weber-Stephen Products LLC, Palatine, IL (US)

(72) Inventors: Michelle Stohl, Glenview, IL (US); Cassandra A.S. McVey, Wheeling, IL (US); Romualdo Sonny Siazon, Woodstock, IL (US); Brett Jessogne, Mundelein, IL (US)

(21) Appl. No.: 16/932,231

(22) Filed: Jul. 17, 2020

(51) Int. Cl. A47J 27/13; A47J 27/00

(52) U.S. Cl. CPC A47J 27/13; A47J 36/06; A47J 27/002

(57) ABSTRACT

Dutch ovens having lids with integral griddles are disclosed. An example Dutch oven includes a pot and a lid. The pot has a rim. The lid is configured to be seated on the rim of the pot. The lid includes a central portion having an upper surface forming a griddle. The upper surface of the central portion is oriented away from the pot when the lid is seated on the rim of the pot.

### FIELD OF THE DISCLOSURE

This disclosure relates generally to Dutch ovens and, more specifically, to Dutch ovens having lids with integral griddles.

### BACKGROUND

Dutch ovens have been used as cooking vessels for well over one hundred years. Conventional Dutch ovens include a thick-walled cooking pot and a tight-fitting lid, with the pot and the lid typically being made of cast iron, cast aluminum, or ceramic. Some known Dutch ovens include a lid having an upwardly-extending rim, with the rim being configured to hold hot coals on the lid and/or, more generally, on the Dutch oven while food is being cooked within the Dutch oven. The rimmed lids of such known Dutch ovens typically have opposed curved surfaces (e.g., lower and upper curved surfaces, or inner and outer curved surfaces), the curvature of which prevents either of the opposed surfaces from being suitable for use as a griddle. The rimmed lids of such known Dutch ovens also typically have a centrally-mounted handle or knob that further prevents the upper/outer surface of the lid from being suitable for use as a griddle.

Other known Dutch ovens include a lid configured to cover the pot when the lid is positioned and/or seated on a rim of the pot and oriented in a first orientation, with the lid being further configured to be used as a cooking pan when the lid is removed from the pot and oriented in a second orientation opposite the first orientation (e.g., when the lid is flipped over and placed on and/or over a heat source). While the lids of such other known Dutch ovens may be suitable for use as a griddle, such use requires that the lid be removed from the pot, and further requires that the lid be flipped over (e.g., flipped upside-down) relative to its position of conventional use as a cover to the pot.

### BRIEF DESCRIPTION OF THE DRAWINGS

FIG. 1 is a perspective view of an example Dutch oven constructed in accordance with teachings of this disclosure.

FIG. 2 is a front view of the Dutch oven of FIG. 1.

FIG. 3 is a right side view of the Dutch oven of FIGS. 1 and 2.

FIG. 4 is a top view of the Dutch oven of FIGS. 1-3.

FIG. 5 is a bottom view of the Dutch oven of FIGS. 1-4.

FIG. 6 is a cross-sectional view of the Dutch oven of FIGS. 1-5 taken along section A-A of FIG. 4.

FIG. 7 is a perspective view of the pot of the Dutch oven of FIGS. 1-6 in isolation.

FIG. 8 is a front view of the pot of the Dutch oven of FIG. 1-7 in isolation.

FIG. 9 is a right side view of the pot of the Dutch oven of FIGS. 1-8 in isolation.

FIG. 10 is a top view of the pot of the Dutch oven of FIGS. 1-9 in isolation.

FIG. 11 is a bottom view of the pot of the Dutch oven of FIGS. 1-10 in isolation.

FIG. 12 is a cross-sectional view of the pot of the Dutch oven of FIGS. 1-11 in isolation and taken along section B-B of FIG. 10.

FIG. 13 is a first perspective view of the lid of the Dutch oven of FIGS. 1-6 in isolation.

FIG. 14 is a second perspective view of the lid of the Dutch oven of FIGS. 1-6 and 13 in isolation.

FIG. 15 is a front view of the lid of the Dutch oven of FIGS. 1-6, 13, and 14 in isolation.

FIG. 16 is a right side view of the lid of the Dutch oven of FIGS. 1-6 and 13-15 in isolation.

FIG. 17 is a top view of the lid of the Dutch oven of FIGS. 1-6 and 13-16 in isolation.

FIG. 18 is a bottom view of the lid of the Dutch oven of FIGS. 1-6 and 13-17 in isolation.

FIG. 19 is a cross-sectional view of the lid of the Dutch oven of FIGS. 1-6 and 13-18 in isolation and taken along section C-C of FIG. 17.

FIG. 20 is a perspective view of an example cooking apparatus having an example modular grate system.

FIG. 21 is a perspective view of the cooking apparatus of FIG. 20 with the central grate of the modular grate system of FIG. 20 removed.

FIG. 22 is a perspective view of the Dutch oven of FIGS. 1-6 docked in the central opening of the modular grate system of FIGS. 20 and 21.

FIG. 23 is a perspective view of the lid of the Dutch oven of FIGS. 1-6 and 13-19 positioned directly on example grates of an example cooking apparatus.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Example Dutch ovens disclosed herein include lids having integral griddles. In some examples, Dutch ovens disclosed herein include a pot having a rim, and further include a lid configured to be seated on the rim of the pot. In some examples, the lid includes a central portion having an upper surface forming a griddle, wherein the upper surface of the central portion is oriented away from the pot when the lid is seated on the rim of the pot. In such examples, the upper surface of the central portion of the lid is advantageously usable as a griddle not only when the lid is seated on the rim of the pot, but also when the lid is removed from the pot and positioned directly on and/or over an underlying heat source (e.g., when the lid is positioned directly on a grate of a grill without being seated on the rim of the pot. In such examples, the lid is advantageously configured to have only a single orientation of use regardless of whether the lid is simply being used to cover the pot or whether the lid is additionally or alternatively being used as a griddle, either with or without the pot.

In some examples, the upper surface of the central portion of the lid is flat and is free of any upwardly-extending protrusions (e.g., handles, knobs, etc.) that might otherwise prevent the upper surface from being suitable for use as a griddle. In some examples, the central portion of the lid has a lower surface (e.g., located opposite the upper surface of the central portion) that includes downwardly-extending protrusions formed as concave dimples. The downwardly-extending protrusions advantageously direct condensation that forms on the lower surface of the central portion downward and/or into a cooking chamber of the pot of the Dutch oven.

In some examples, the lid includes a lip coupled to and extending upwardly from the central portion. The lip advantageously provides a peripheral boundary to the upper surface of the central portion, which further facilitates the upper surface of the central portion being used as a griddle. In some examples, the lip is advantageously configured to prevent the lid from being seated on the rim of the pot in an upside-down orientation.

In some examples, the pot includes feet coupled to and extending downwardly from a base of the pot. The pot is advantageously configured to be docked on a modular grate system, with the feet being located within a central opening of the modular grate system when the pot is docked thereon.

The above-identified features as well as other advantageous features of example Dutch ovens disclosed herein are further described below in connection with the figures of the application. As used herein, the term “configured” means sized, shaped, arranged, structured, oriented, positioned and/or located. For example, in the context of a first object configured to fit within a second object, the first object is sized, shaped, arranged, structured, oriented, positioned and/or located to fit within the second object. As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary. For example, a plurality of trees can circumscribe a field.

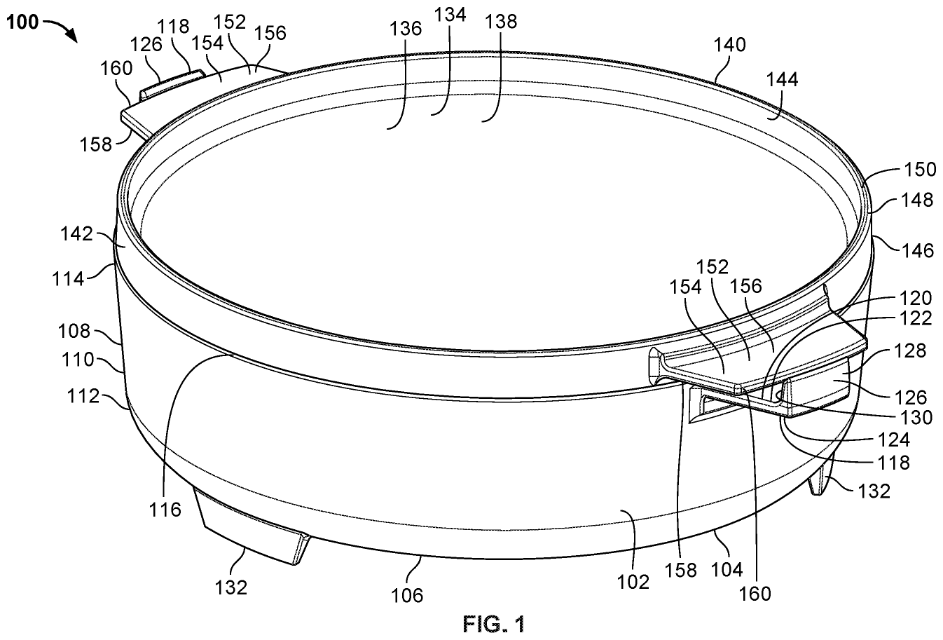

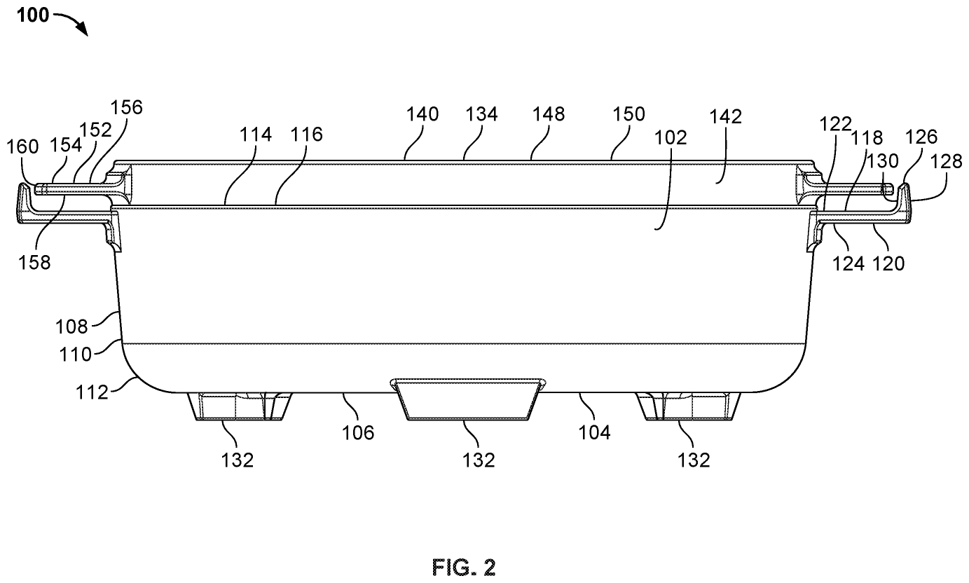

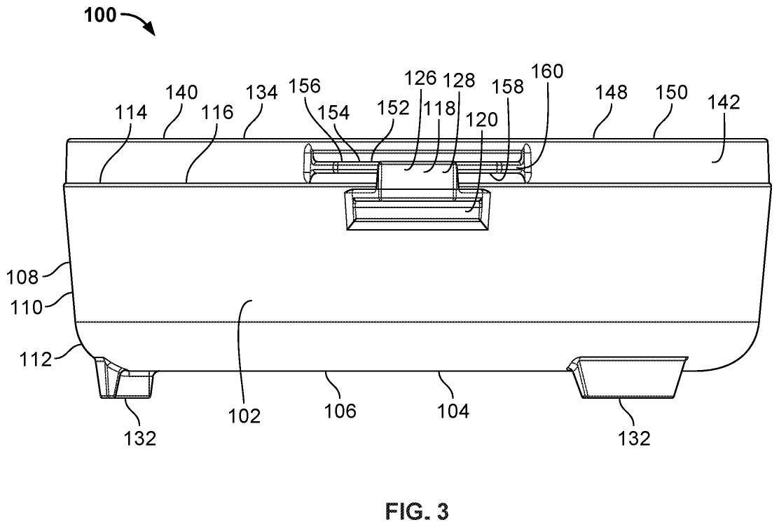

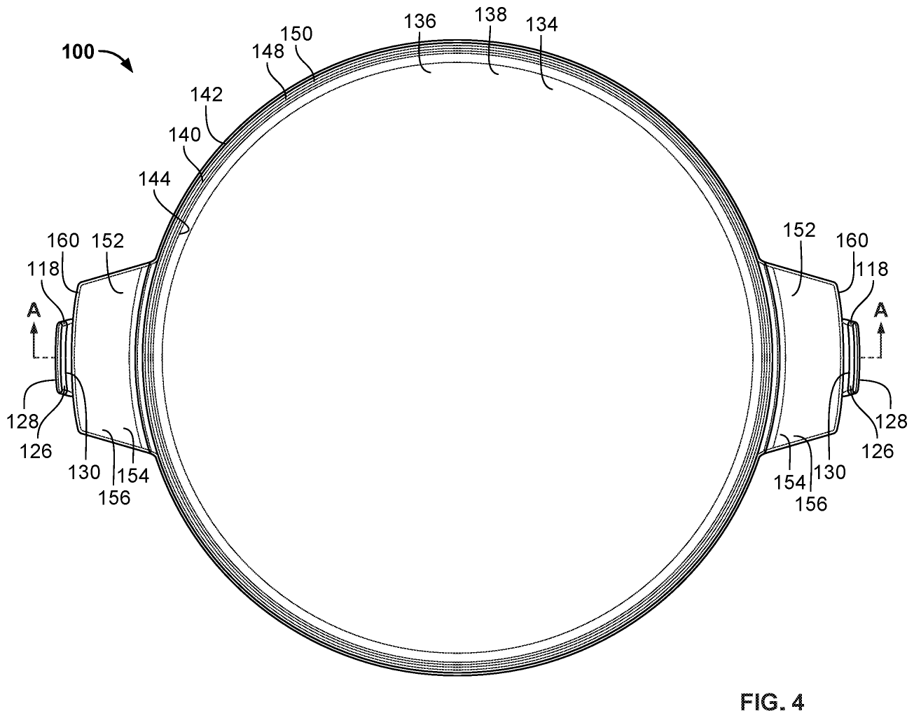

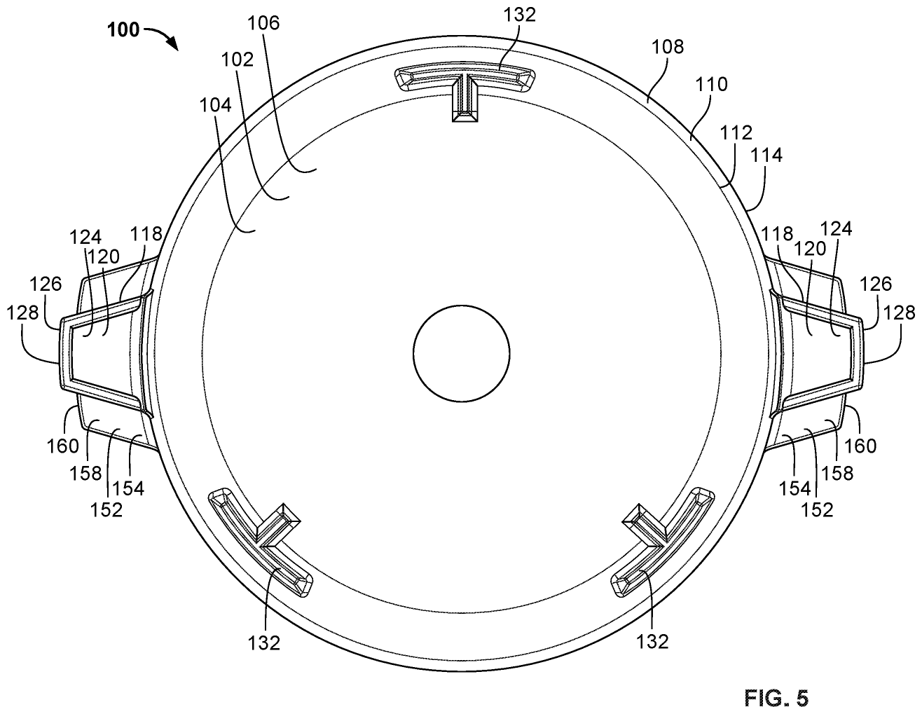

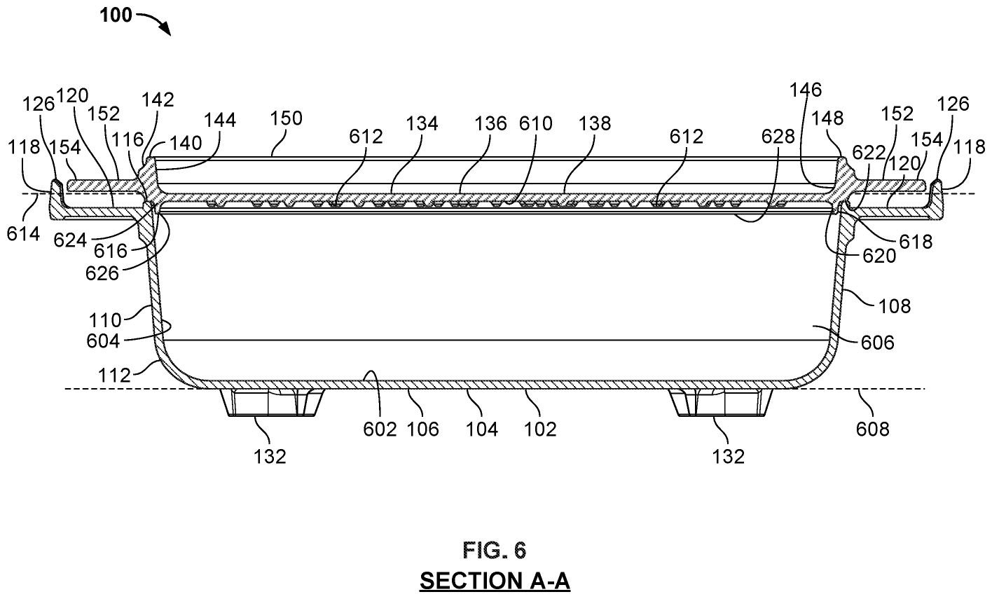

FIG. 1 is a perspective view of an example Dutch oven 100 constructed in accordance with teachings of this disclosure. FIG. 2 is a front view of the Dutch oven 100 of FIG. 1. FIG. 3 is a rear view of the Dutch oven 100 of FIGS. 1 and 2. FIG. 3 is a right side view of the Dutch oven 100 of FIGS. 1 and 2. FIG. 4 is a top view of the Dutch oven 100 of FIGS. 1-3. FIG. 5 is a bottom view of the Dutch oven 100 of FIGS. 1-4. FIG. 6 is a cross-sectional view of the Dutch oven 100 of FIGS. 1-5 taken along section A-A of FIG. 4.

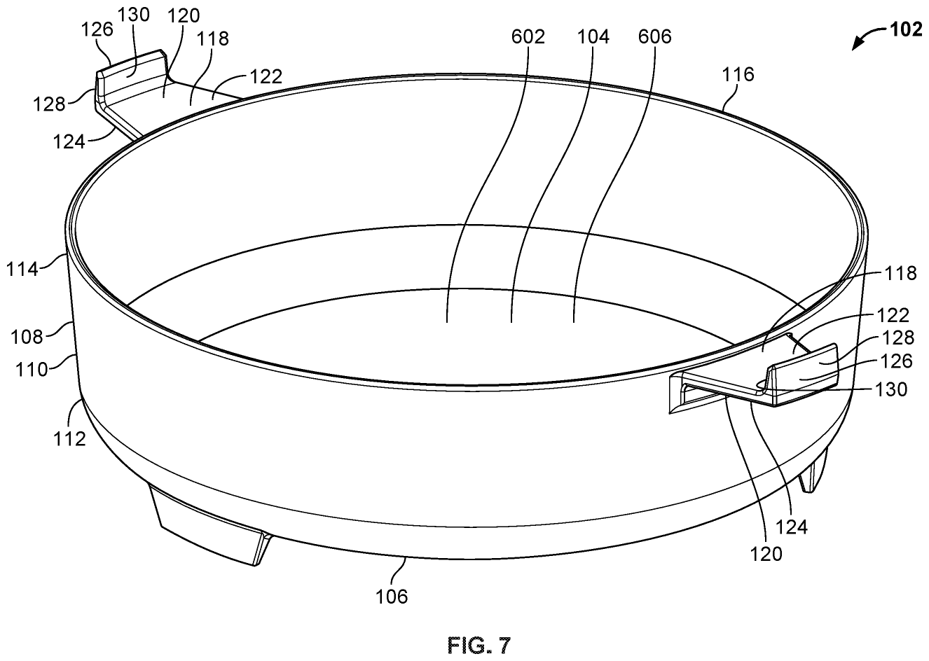

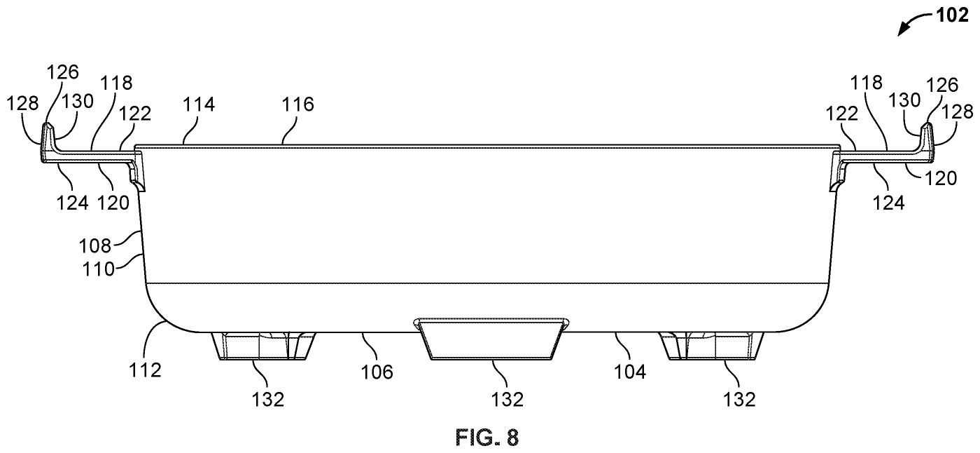

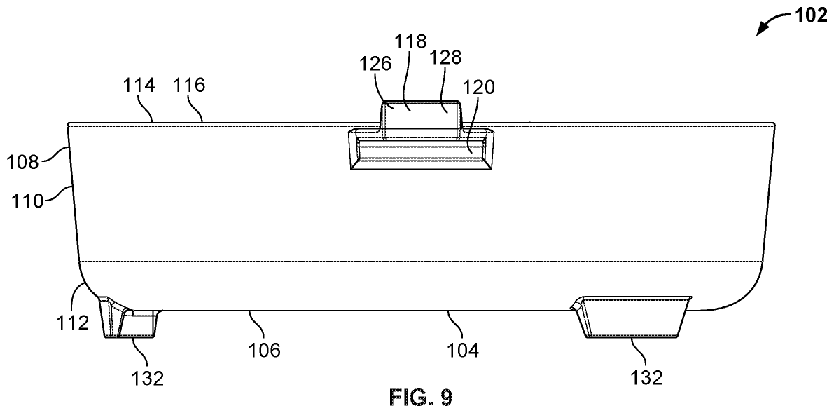

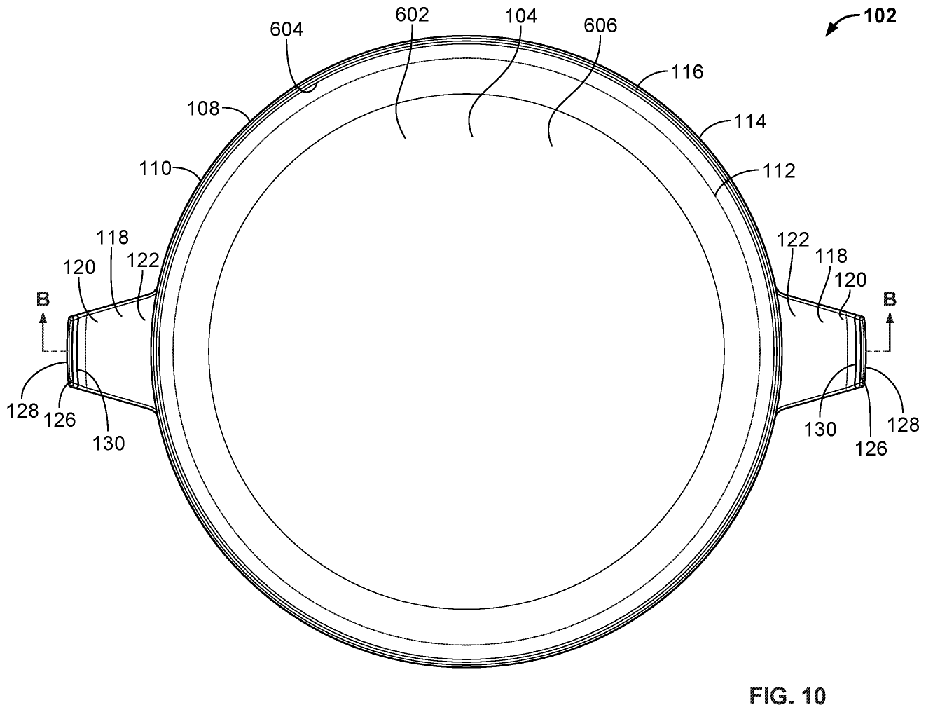

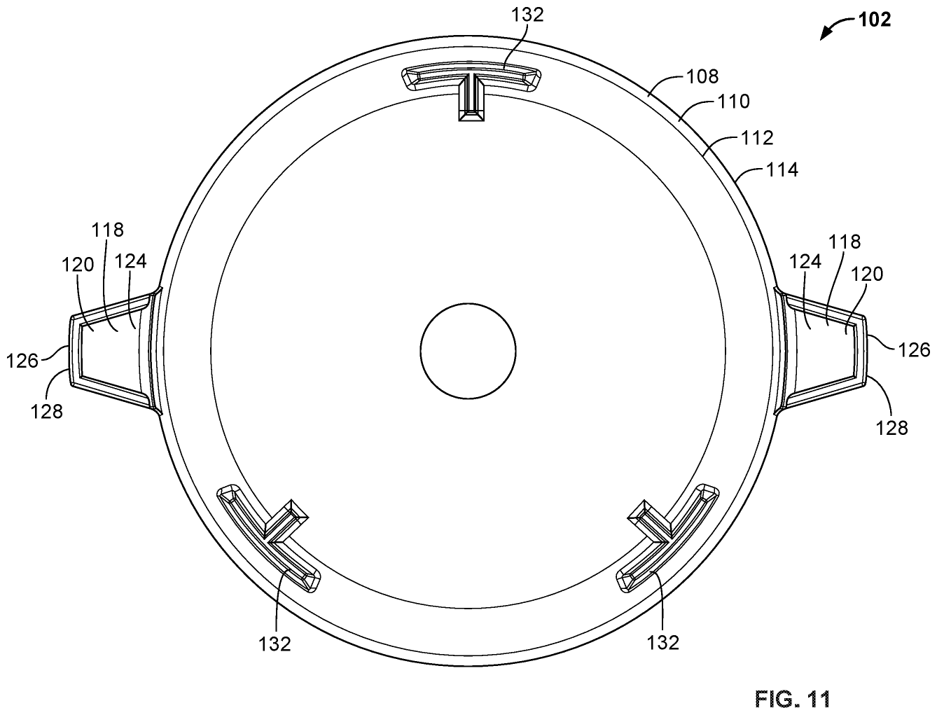

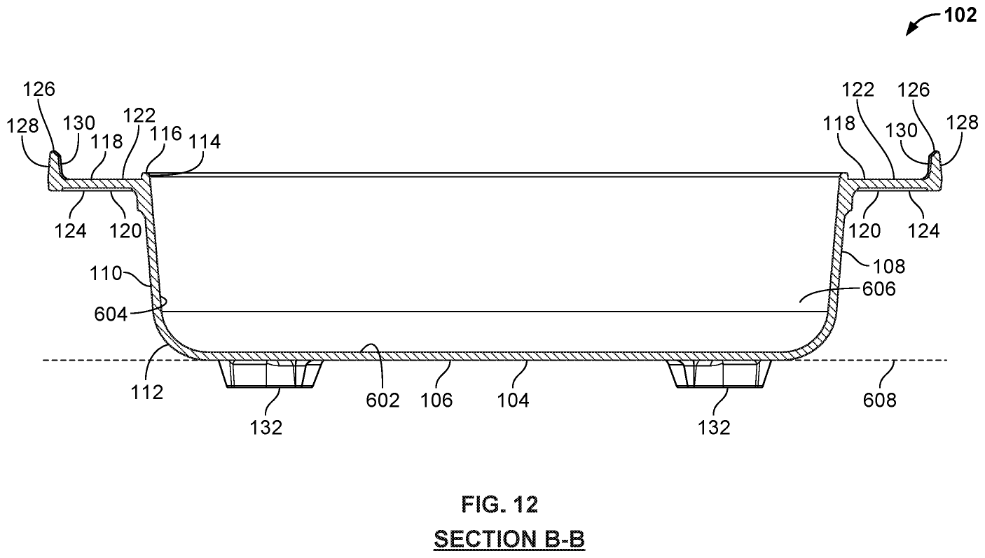

The Dutch oven 100 of FIGS. 1-6 includes an example pot 102. FIG. 7 is a perspective view of the pot 102 of the Dutch oven 100 of FIGS. 1-6 in isolation. FIG. 8 is a front view of the pot 102 of the Dutch oven 100 of FIG. 1-7 in isolation. FIG. 9 is a right side view of the pot 102 of the Dutch oven 100 of FIGS. 1-8 in isolation. FIG. 10 is a top view of the pot 102 of the Dutch oven 100 of FIGS. 1-9 in isolation. FIG. 11 is a bottom view of the pot 102 of the Dutch oven 100 of FIGS. 1-10 in isolation. FIG. 12 is a cross-sectional view of the pot 102 of the Dutch oven 100 of FIGS. 1-11 in isolation, and taken along section B-B of FIG. 10.

In the illustrated example of FIGS. 1-12, the pot 102 includes an example base 104 having an example exterior surface 106 (e.g., a lower surface of the base 104) and an example interior surface 602 (e.g., an upper surface of the base 104) located opposite the exterior surface 106 of the base 104. The pot 102 is configured such that the exterior surface 106 of the base 104 contacts, is positioned above, and/or is otherwise directed toward an underlying heat source when the Dutch oven 100 is in use. In the illustrated example of FIGS. 1-12, the base 104 of the pot 102 has a circular profile. In other examples, the base 104 of the pot 102 can have a non-circular profile. For example, the base 104 of the pot 102 can have an elliptical profile, a triangular profile, a rectangular profile, a pentagonal profile, a hexagonal profile, etc.

The pot 102 of FIGS. 1-12 further includes an example sidewall 108 coupled to and extending upwardly from the base 104. In the illustrated example of FIGS. 1-12, the sidewall 108 of the pot 102 is integrally formed with the base 104 of the pot 102 such that no joints, seams, and/or welds exist between the sidewall 108 and the base 104, and/or such that the sidewall 108 cannot be removed and/or separated from the base 104 absent destructive measures. In other examples, the sidewall 108 can be coupled to the base 104 via one or more permanent, temporary, and/or removable mechanical fasteners(s), adhesive(s), and/or bonding agent(s).

The sidewall 108 of the pot 102 of FIGS. 1-12 includes an example exterior surface 110 and an example interior surface 604 located opposite the exterior surface 110 of the sidewall 108. The interior surface 604 of the sidewall 108 and the interior surface 602 of the base 104 collectively define an example cooking chamber 606 of the pot 102 and/or, more, generally, of the Dutch oven 100. The pot 102 is configured such that the interior surface 604 of the sidewall 108 and the interior surface 602 of the base 104 are contacted by food located within the cooking chamber 606 of the pot 102 when the Dutch oven 100 is in use. In the illustrated example of FIGS. 1-12, the sidewall 108 of the pot 102 has a circular profile. In other examples, the sidewall 108 of the pot 102 can have a non-circular profile. For example, the sidewall 108 of the pot 102 can have an elliptical profile, a triangular profile, a rectangular profile, a pentagonal profile, a hexagonal profile, etc. In some examples, the profile of the sidewall 108 is a shape that matches the shape of the profile of the base 104 (e.g., a circular sidewall 108 and a circular base 104). In other examples, the profile of the sidewall 108 can have a shape that does not match the shape of the profile of the base 104 (e.g., a rectangular sidewall 108 and a circular base 104).

In the illustrated example of FIGS. 1-12, the sidewall 108 of the pot 102 extends upwardly from the base 104 of the pot 102 at an angle greater than ninety degrees relative to an example plane 608 defined by the exterior surface 106 of the base 104. Thus, the sidewall 108 has an outward taper (e.g., a radially outward taper) as it extends upwardly away from the base 104. In other examples, the sidewall 108 of the pot 102 can extend upwardly from the base 104 of the pot 102 at an angle less than ninety degrees relative to the plane 608 defined by the exterior surface 106 of the base 104, such that the sidewall 108 has an inward taper (e.g., a radially inward taper) as it extends upwardly away from the base 104. In still other examples, the sidewall 108 of the pot 102 can extend upwardly from the base 104 of the pot 102 at an angle of ninety degrees relative to the plane 608 defined by the exterior surface 106 of the base 104, such that the sidewall 108 is orthogonal to the base 104 and has neither in outward taper nor an inward taper relative thereto.

The sidewall 108 of the pot 102 of FIGS. 1-12 further includes an example base end 112 at which the sidewall 108 joins and/or meets with the base 104 of the pot 102, and an example free end 114 located opposite the base end 112 of the sidewall 108. The free end 114 of the sidewall 108 forms an example rim 116 of the pot 102. The free end 114 of the sidewall 108 and/or the rim 116 of the pot 102 is/are generally oriented in an upward direction facing away from (e.g., opposite) the exterior surface 106 of the base 104 of the pot 102. The rim 116 of the pot 102 is configured to support a lip of a lid of the Dutch oven 100 of FIGS. 1-12, as further described below.

The pot 102 of FIGS. 1-12 further includes example handles 118 coupled to and extending outwardly (e.g., radially outwardly) from the exterior surface 110 of the sidewall 108. In the illustrated example of FIGS. 1-12, the handles 118 of the pot 102 are integrally formed with the sidewall 108 of the pot 102 such that no joints, seams, and/or welds exist between the handles 118 and the sidewall 108, and/or such that the handles 118 cannot be removed and/or separated from the sidewall 108 absent destructive measures. In other examples, the handles 118 can be coupled to the sidewall 108 via one or more permanent, temporary, and/or removable mechanical fasteners(s), adhesive(s), and/or bonding agent(s).

Each of the handles 118 of the pot 102 of FIGS. 1-12 includes an example first flange 120 extending outwardly from the exterior surface 110 of the sidewall 108 and having an example upper surface 122 and an example lower surface 124 located opposite the upper surface 122. Each of the handles 118 of the pot 102 of FIGS. 1-12 further includes an example second flange 126 extending upwardly from the first flange 120 and having an example exterior surface 128 and an example interior surface 130 located opposite the exterior surface 128. The first flanges 120 and the second flanges 126 of the handles 118 are configured to be gripped and/or grasped by a user of the Dutch oven 100 in connection with moving the pot 102 of the Dutch oven 100 from one location to another location. For example, the first flanges 120 and/or the second flanges 126 of the handles 118 can be gripped and/or grasped by a user of the Dutch oven 100 in connection with moving the pot 102 into and/or out of an opening of a modular grate system of a cooking apparatus, as further described below. The handles 118 of the pot 102 of FIGS. 1-12 are additionally configured to align with and/or receive corresponding handles of a lid of the Dutch oven 100 of FIGS. 1-12, as further described below.

In the illustrated example of FIGS. 1-12, the pot 102 includes two handles 118. In other examples, the pot 102 can include a different number (e.g. 1, 3, 4, etc.) of handles 118. In the illustrated example of FIGS. 1-12, the first flanges 120 of the handles 118 are parallel to the plane 608 defined by the exterior surface 106 of the base 104. In other examples, one or more of the first flanges 120 of the handles 118 can be angled (e.g., upwardly or downwardly) relative to the plane 608 defined by the exterior surface 106 of the base 104. In the illustrated example of FIGS. 1-12, the first flanges 120 of the handles 118 are located adjacent the free end 114 of the sidewall 108 of the pot 102. In other examples, one or more of the first flanges 120 of the handles 118 can be located at a more central position along the sidewall 108 (e.g., midway between the base end 112 and the free end 114) of the pot 102. In the illustrated example of FIGS. 1-12, the upper surface 122 and the lower surface 124 of each first flange 120 of the handles 118 are planar (e.g., flat). In other examples, the upper surface 122 and/or the lower surface 124 of one or both of the first flanges 120 of the handles 118 can be curved or otherwise contoured. In the illustrated example of FIGS. 1-12, each of the first flanges 120 of the handles 118 has a generally trapezoidal profile. In other examples, one or both of the first flanges 120 of the handles 118 can have a non-trapezoidal profile. For example, one or both of the first flanges 120 of the handles 118 can have a circular profile, an elliptical profile, a triangular profile, a rectangular profile, a pentagonal profile, a hexagonal profile, etc.

The pot 102 of FIGS. 1-12 further includes example feet 132 coupled to and extending downwardly from the exterior surface 106 of the base 104. In the illustrated example of FIGS. 1-12, the feet 132 of the pot 102 are integrally formed with the base 104 of the pot 102 such that no joints, seams, and/or welds exist between the feet 132 and the base 104, and/or such that the feet 132 cannot be removed and/or separated from the base 104 absent destructive measures. In other examples, the feet 132 can be coupled to the base 104 via one or more permanent, temporary, and/or removable mechanical fasteners(s), adhesive(s), and/or bonding agent(s).

The feet 132 of the pot 102 of FIGS. 1-12 are configured to contact an underlying support surface (e.g., a countertop, a tabletop, a grill grate, etc.) such that the exterior surface 106 of the base 104 of the pot 102 is raised above and/or off of the underlying support surface when the pot 102 is positioned thereon. The feet 132 of the pot 102 of FIGS. 1-12 are additionally configured to guide, locate, position, and/or dock the pot 102 and/or, more generally, the Dutch oven 100 relative to an opening of a modular grate system, as further described below. In the illustrated example of FIGS. 1-12, the pot 102 includes three feet 132. In other examples, the pot 102 can include a different number (e.g. 1, 2, 4, etc.) of feet 132. In the illustrated example of FIGS. 1-12, each of the feet 132 of the pot 102 has a generally T-shaped profile. In other examples, one or more of the feet 132 can have a non-T-shaped profile. For example, one or more of the feet 132 can have a circular profile, an elliptical profile, a triangular profile, a rectangular profile, a pentagonal profile, a hexagonal profile, etc.

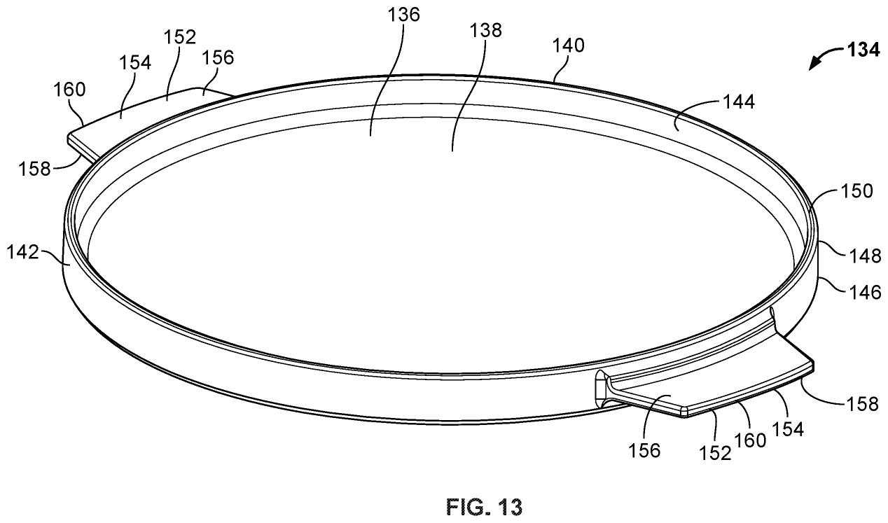

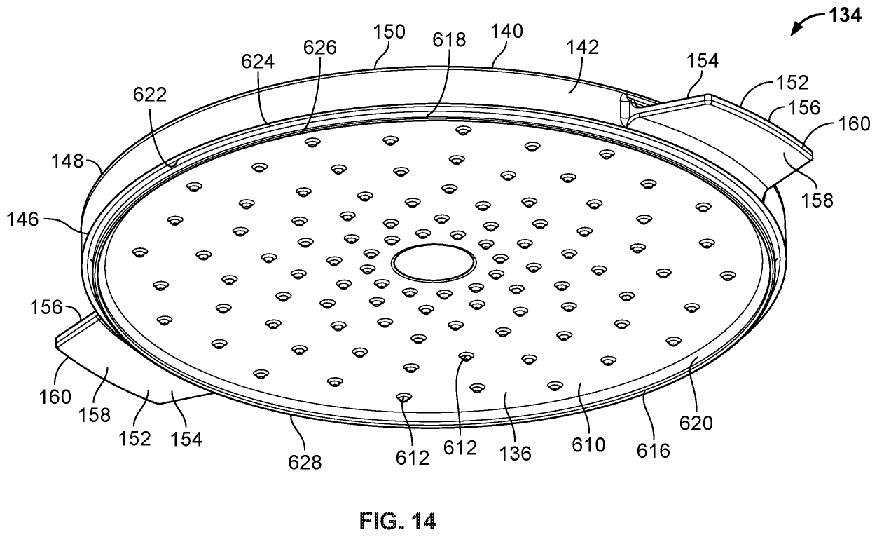

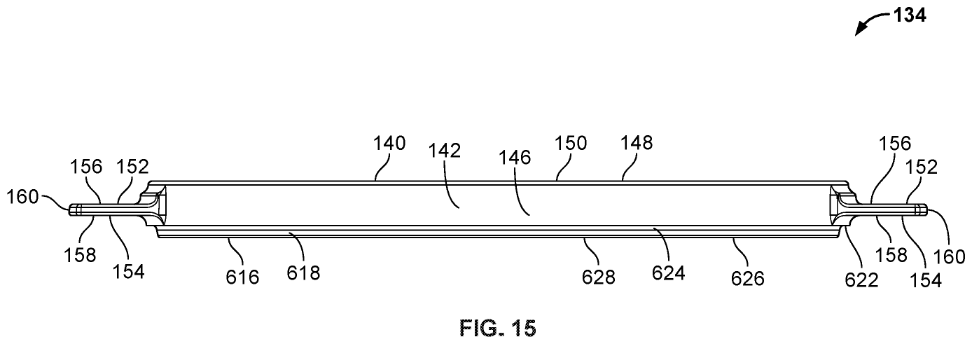

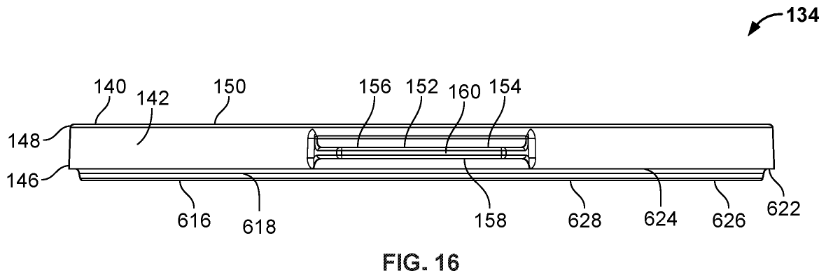

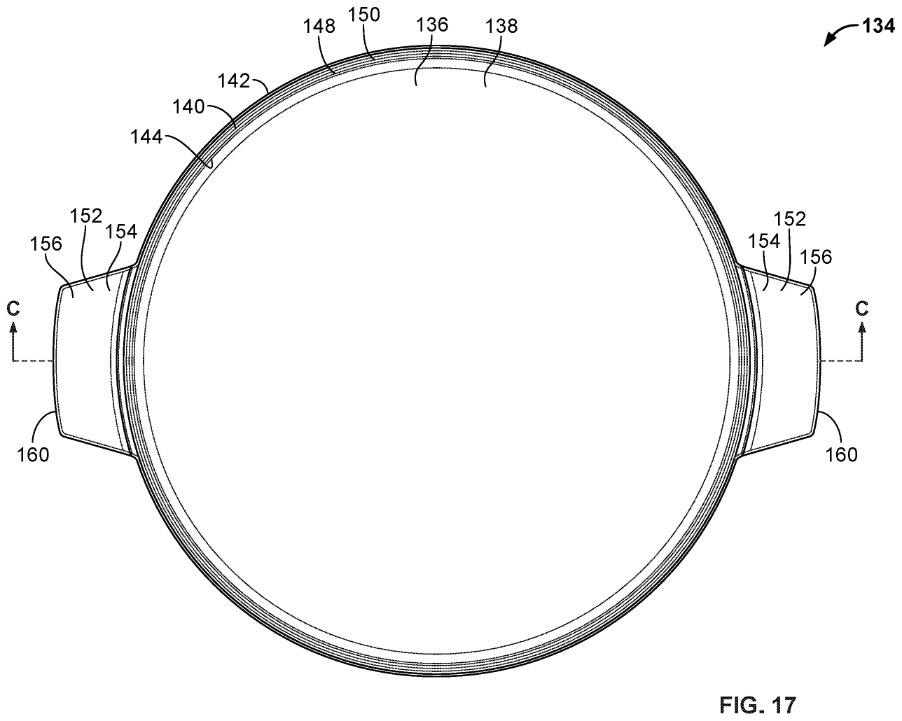

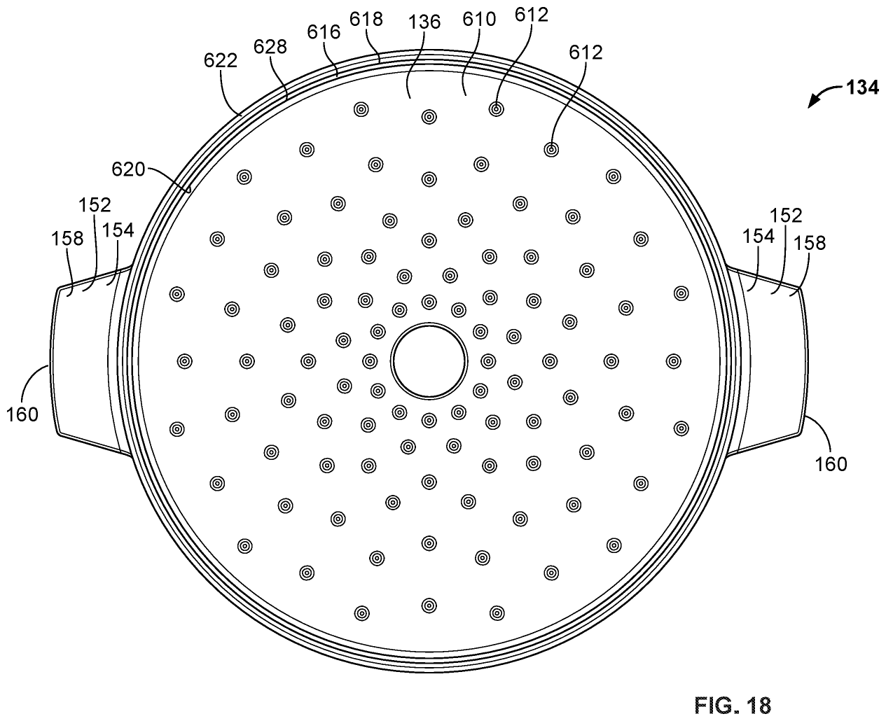

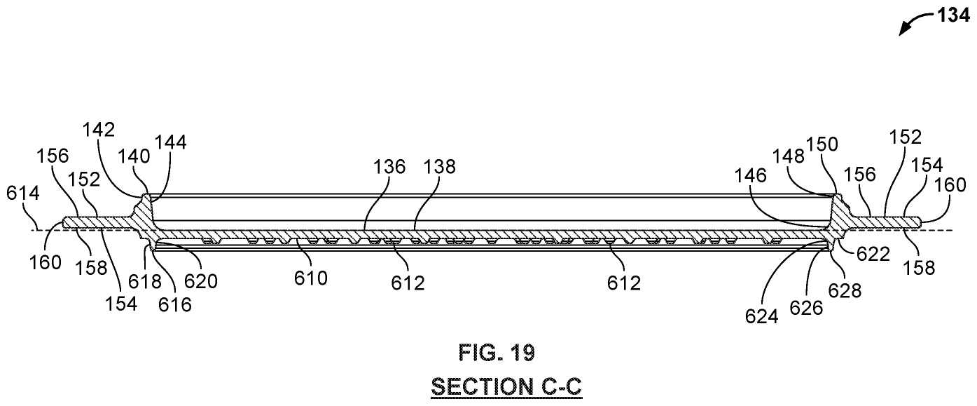

The Dutch oven 100 of FIGS. 1-8 further includes an example lid 134. FIG. 13 is a first perspective view of the lid 134 of the Dutch oven 100 of FIGS. 1-6 in isolation. FIG. 14 is a second perspective view of the lid 134 of the Dutch oven 100 of FIGS. 1-6 and 13 in isolation. FIG. 15 is a front view of the lid 134 of the Dutch oven 100 of FIGS. 1-6, 13, and 14 in isolation. FIG. 16 is a right side view of the lid 134 of the Dutch oven 100 of FIGS. 1-6 and 13-15 in isolation. FIG. 17 is a top view of the lid 134 of the Dutch oven 100 of FIGS. 1-6 and 13-16 in isolation. FIG. 18 is a bottom view of the lid 134 of the Dutch oven 100 of FIGS. 1-6 and 13-17 in isolation. FIG. 19 is a cross-sectional view of the lid 134 of the Dutch oven 100 of FIGS. 1-6 and 13-18 in isolation, and taken along section C-C of FIG. 17.

In the illustrated example of FIGS. 1-6 and 13-19, the lid 134 includes an example central portion 136 having an example upper surface 138 and example lower surface 610 located opposite the upper surface 138. The lid 134 is configured such that upper surface 138 of the central portion 136 constitutes and/or is suitable for use as a griddle. In some examples, the upper surface 138 of the central portion 136 of the lid 134 constitutes and/or is usable as a griddle when the lid 134 is positioned and/or seated on the rim 116 of the pot 102 of the Dutch oven 100 (e.g., as shown in FIGS. 1-8), with the upper surface 138 of the central portion 136 being directed away from the base 104 of the pot 102 and the lower surface 610 of the central portion 136 being directed toward the base 104 of the pot 102. In other examples, the upper surface 138 of the central portion 136 of the lid 134 constitutes and/or is usable as a griddle when the lid 134 is positioned directly on and/or over an underlying heat source (e.g., when the lid 134 is positioned directly on a grate of a grill without being positioned on the rim 116 of the pot 102 of the Dutch oven 100), with the upper surface 138 of the central portion 136 being directed away from the underlying heat source and the lower surface 610 of the central portion 136 being directed toward the underlying heat source. In the illustrated example of FIGS. 1-6 and 13-19, the central portion 136 of the lid 134 has a circular profile. In other examples, the central portion 136 of the lid 134 can have a non-circular profile. For example, the central portion 136 of the lid 134 can have an elliptical profile, a triangular profile, a rectangular profile, a pentagonal profile, a hexagonal profile, etc.

The upper surface 138 of the central portion 136 of the lid 134 of FIGS. 1-8 and 13-19 is a flat, planar surface lacking handles and knobs, and, more generally, lacking upwardly-extending protrusions of any form. The absence of such handles, knobs, and upwardly-extending protrusions from the upper surface 138 of the central portion 136 of the lid 134 facilitates the upper surface 138 of the central portion 136 of the lid 134 being used as a griddle. The lower surface 610 of the central portion 136 of the lid 134 of FIGS. 1-8 and 13-19 is likewise a flat, planar surface. However, unlike the upper surface 138 of the central portion 136, the lower surface 610 of the central portion 136 includes example protrusions 612 (e.g., concave dimples) extending downwardly therefrom. The protrusions 612 are configured to direct condensation that forms on the lower surface 610 of the central portion 136 downward and/or into the cooking chamber 606 of the pot 102 of the Dutch oven 100. The protrusions 612 render the lower surface 610 of the central portion 136 of the lid 134 unsuitable for use as a griddle. In the illustrated example of FIGS. 1-6 and 13-19, the protrusions 612 of the lid 134 have a circular profile. In other examples, the protrusions 612 of the lid 134 can have a non-circular profile. For example, the protrusions 612 of the lid 134 can have an elliptical profile, a triangular profile, a rectangular profile, a pentagonal profile, a hexagonal profile, etc.

The lid 134 of FIGS. 1-6 and 13-19 further includes a first example lip 140 coupled to and extending upwardly from the central portion 136. In the illustrated example of FIGS. 1-6 and 13-19, the first lip 140 of the lid 134 is integrally formed with the central portion 136 of the lid 134 such that no joints, seams, and/or welds exist between the first lip 140 and the central portion 136, and/or such that the first lip 140 cannot be removed and/or separated from the central portion 136 absent destructive measures. In other examples, the first lip 140 can be coupled to the central portion 136 via one or more permanent, temporary, and/or removable mechanical fasteners(s), adhesive(s), and/or bonding agent(s).

The first lip 140 of the lid 134 of FIGS. 1-6 and 13-19 includes an example exterior surface 142 and an example interior surface 144 located opposite the exterior surface 142 of the first lip 140. In the illustrated example of FIGS. 1-6, the exterior surface 142 of the first lip 140 of the lid 134 aligns with (e.g., is flush with) the exterior surface 110 of the sidewall 108 of the pot 102 when the lid 134 is positioned and/or seated on the rim 116 of the pot 102. The lid 134 is configured such that the interior surface 144 of the first lip 140 provides a peripheral boundary for food being cooked on the upper surface 138 of the central portion 136 of the lid 134 when the central portion 136 is being used as a griddle. In the illustrated example of FIGS. 1-6 and 13-19, the first lip 140 of the lid 134 has a circular profile. In other examples, the first lip 140 of the lid 134 can have a non-circular profile. For example, the first lip 140 of the lid 134 can have an elliptical profile, a triangular profile, a rectangular profile, a pentagonal profile, a hexagonal profile, etc. In some examples, the profile of the first lip 140 is a shape that matches the shape of the profile of the central portion 136 (e.g., a circular first lip 140 and a circular central portion 136). In other examples, the profile of the first lip 140 can have a shape that does not match the shape of the profile of the central portion 136 (e.g., a rectangular first lip 140 and a circular central portion 136).

In the illustrated example of FIGS. 1-6 and 13-19, the first lip 140 of the lid 134 extends upwardly from the central portion 136 of the lid 134 at an angle greater than ninety degrees relative to an example plane 614 defined by the upper surface 138 of the central portion 136. Thus, the first lip 140 has an outward taper (e.g., a radially outward taper) as it extends upwardly away from the central portion 136. In other examples, the first lip 140 of the lid 134 can extend upwardly from the central portion 136 of the lid 134 at an angle less than ninety degrees relative to the plane 614 defined by the upper surface 138 of the central portion 136, such that the first lip 140 has an inward taper (e.g., a radially inward taper) as it extends upwardly away from the central portion 136. In still other examples, the first lip 140 of the lid 134 can extend upwardly from the central portion 136 of the lid 134 at an angle of ninety degrees relative to the plane 614 defined by the upper surface 138 of the central portion 136, such that the first lip 140 is orthogonal to the central portion 136 and has neither in outward taper nor an inward taper relative thereto.

The first lip 140 of the lid 134 of FIGS. 1-6 and 13-19 further includes an example base end 146 at which the first lip 140 joins and/or meets with the central portion 136 of the lid 134, and an example free end 148 located opposite the base end 146 of the first lip 140. The free end 148 of the first lip 140 forms an example upper rim 150 of the lid 134. The free end 148 of the first lip 140 and/or the upper rim 150 of the lid 134 is/are generally oriented in an upward direction facing away from (e.g., opposite) the lower surface 610 of the central portion 136 of the lid 134. In some examples, the upper rim 150 of the lid 134 is configured to block and/or otherwise prevent the lid 134 of the Dutch oven 100 from being placed and/or seated on the rim 116 of the pot 102 when the lid 134 is misoriented, as may occur when the orientation of the lid 134 is inadvertently flipped such that the upper surface 138 of the central portion 136 is directed toward the cooking chamber 606 of the pot 102. The lid 134 of the Dutch oven 100 is accordingly configured to have only a single orientation of use regardless of whether the lid 134 is simply being used to cover the pot 102 or whether the lid 134 is additionally or alternatively being used as a griddle (e.g., either with or without the pot 102).

The lid 134 of FIGS. 1-6 and 13-19 further includes a second example lip 616 coupled to and extending downwardly from the central portion 136. In the illustrated example of FIGS. 1-6 and 13-19, the second lip 616 of the lid 134 is integrally formed with the central portion 136 of the lid 134 such that no joints, seams, and/or welds exist between the second lip 616 and the central portion 136, and/or such that the second lip 616 cannot be removed and/or separated from the central portion 136 absent destructive measures. In other examples, the second lip 616 can be coupled to the central portion 136 via one or more permanent, temporary, and/or removable mechanical fasteners(s), adhesive(s), and/or bonding agent(s).

The second lip 616 of the lid 134 of FIGS. 1-6 and 13-19 includes an example exterior surface 618 and an example interior surface 620 located opposite the exterior surface 618 of the second lip 616. In the illustrated example of FIGS. 1-6, the exterior surface 618 of the second lip 616 of the lid 134 is circumscribed by and/or nested within the interior surface 604 of the sidewall 108 of the pot 102 when the lid 134 is positioned and/or seated on the rim 116 of the pot 102. The lid 134 is configured such that the exterior surface 618 of the second lip 616 provides a guide for properly positioning and/or seating the lid 134 on the rim 116 of the pot 102. In this regard, the lid 134 further includes an example annular seat 622 configured to contact the rim 116 of the pot 102 when the lid 134 is positioned thereon. In the illustrated example of FIGS. 1-6 and 13-19, the second lip 616 of the lid 134 has a circular profile. In other examples, the second lip 616 of the lid 134 can have a non-circular profile. For example, the second lip 616 of the lid 134 can have an elliptical profile, a triangular profile, a rectangular profile, a pentagonal profile, a hexagonal profile, etc. In some examples, the profile of the second lip 616 is a shape that matches the shape of the profile of the central portion 136 (e.g., a circular second lip 616 and a circular central portion 136). In other examples, the profile of the second lip 616 can have a shape that does not match the shape of the profile of the central portion 136 (e.g., a rectangular second lip 616 and a circular central portion 136).

In the illustrated example of FIGS. 1-6 and 13-19, the second lip 616 of the lid 134 extends downwardly from the central portion 136 of the lid 134 at an angle less than ninety degrees relative to the plane 614 defined by the upper surface 138 of the central portion 136. Thus, the second lip 616 has an inward taper (e.g., a radially inward taper) as it extends downwardly away from the central portion 136. In other examples, the second lip 616 of the lid 134 can extend downwardly from the central portion 136 of the lid 134 at an angle greater than ninety degrees relative to the plane 614 defined by the upper surface 138 of the central portion 136, such that the second lip 616 has an outward taper (e.g., a radially outward taper) as it extends downwardly away from the central portion 136. In still other examples, the second lip 616 of the lid 134 can extend downwardly from the central portion 136 of the lid 134 at an angle of ninety degrees relative to the plane 614 defined by the upper surface 138 of the central portion 136, such that the second lip 616 is orthogonal to the central portion 136 and has neither in inward taper nor an outward taper relative thereto.

The second lip 616 of the lid 134 of FIGS. 1-6 and 13-19 further includes an example base end 624 at which the second lip 616 joins and/or meets with the central portion 136 of the lid 134, and an example free end 626 located opposite the base end 624 of the second lip 616. The free end 626 of the second lip 616 forms an example lower rim 628 of the lid 134. The free end 626 of the second lip 616 and/or the lower rim 628 of the lid 134 is/are generally oriented in a downward direction facing away from (e.g., opposite) the upper surface 138 of the central portion 136 of the lid 134.

The lid 134 of FIGS. 1-6 and 13-19 further includes example handles 152 coupled to and extending outwardly (e.g., radially outwardly) from the exterior surface 142 of the first lip 140. In the illustrated example of FIGS. 1-6 and 13-19, the handles 152 of the lid 134 are integrally formed with the first lip 140 of the lid 134 such that no joints, seams, and/or welds exist between the handles 152 and the first lip 140, and/or such that the handles 152 cannot be removed and/or separated from the first lip 140 absent destructive measures. In other examples, the handles 152 can be coupled to the first lip 140 via one or more permanent, temporary, and/or removable mechanical fasteners(s), adhesive(s), and/or bonding agent(s).

Each of the handles 152 of the lid 134 of FIGS. 1-6 and 13-19 includes an example flange 154 extending outwardly from the exterior surface 142 of the first lip 140 and having an example upper surface 156, an example lower surface 158 located opposite the upper surface 156, and an example outer edge 160 located between the upper surface 156 and the lower surface 158. The flanges 154 of the handles 152 are configured to be gripped and/or grasped by a user of the Dutch oven 100 in connection with moving the pot 102 and/or the lid 134 of the Dutch oven 100 from one location to another location. For example, the flanges 154 of the handles 152 can be gripped and/or grasped by a user of the Dutch oven 100 in connection with moving the pot 102 into and/or out of an opening of a modular grate system of a cooking apparatus while the lid 134 is positioned and/or seated on the rim 116 of the pot 102, as further described below. The outer edges 160 of the handles 152 of the lid 134 of FIGS. 1-6 and 13-19 are configured to be collectively circumscribed by and/or collectively nested within the second flanges 126 of the handles 118 of the pot 102 of FIGS. 1-12 when the lid 134 is positioned and/or seated on the rim 116 of the pot 102, as generally shown in FIGS. 1-6.

In the illustrated example of FIGS. 1-6 and 13-19, the lid 134 includes two handles 152. In other examples, the lid 134 can include a different number (e.g. 1, 3, 4, etc.) of handles 152. In the illustrated example of FIGS. 1-6 and 13-19, the flanges 154 of the handles 152 are parallel to the plane 614 defined by the upper surface 138 of the central portion 136. In other examples, one or more of the flanges 154 of the handles 152 can be angled (e.g., upwardly or downwardly) relative to the plane 614 defined by the upper surface 138 of the central portion 136. In the illustrated example of FIGS. 1-6 and 13-19, the upper surface 156 and the lower surface 158 of each flange 154 of the handles 152 are planar (e.g., flat). In other examples, the upper surface 156 and/or the lower surface 158 of one or both of the flanges 154 of the handles 152 can be curved or otherwise contoured. In the illustrated example of FIGS. 1-6 and 13-19, each of the flanges 154 of the handles 152 has a generally trapezoidal profile. In other examples, one or both of the flanges 154 of the handles 152 can have a non-trapezoidal profile. For example, one or both of the flanges 154 of the handles 152 can have a circular profile, an elliptical profile, a triangular profile, a rectangular profile, a pentagonal profile, a hexagonal profile, etc.

In some examples, the pot 102 of FIGS. 1-12 can include one or more additional structure(s) and/or component(s) beyond those shown and described in connection with FIGS. 1-12. In other examples, the pot 102 can omit one or more structure(s) and/or component(s) relative to those shown and described in connection with FIGS. 1-12. In some examples, the lid 134 of FIGS. 1-6 and 13-19 can include one or more additional structure(s) and/or component(s) beyond those shown and described in connection with FIGS. 1-6 and 13-19. In other examples, the lid 134 can omit one or more structure(s) and/or component(s) relative to those shown and described in connection with FIGS. 1-6 and 13-19. The Dutch oven 100 of FIGS. 1-6 can include one or more additional structure(s) and/or component(s) beyond those shown and described in connection with FIGS. 1-6. In still other examples, the Dutch oven 100 can omit one or more structure(s) and/or component(s) relative to those shown and described in connection with FIGS. 1-6.

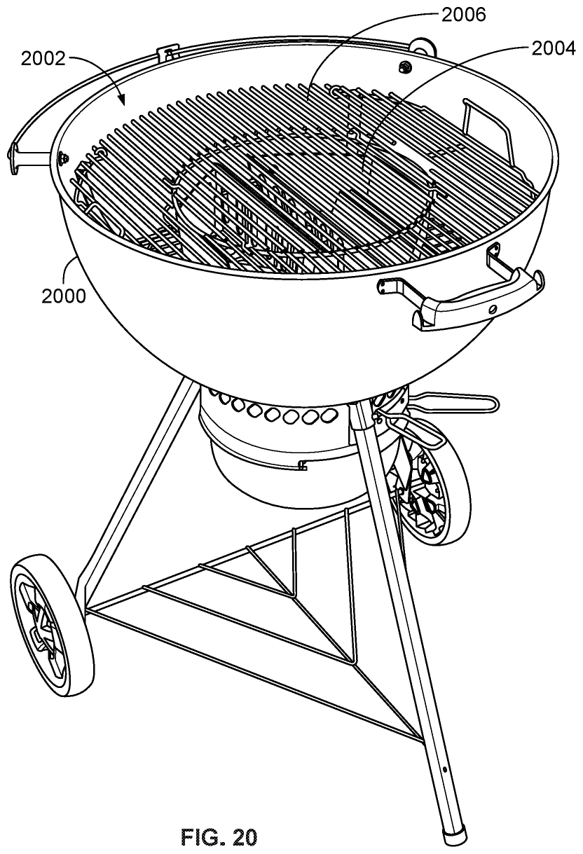

FIG. 20 is a perspective view of an example cooking apparatus 2000 having an example modular grate system 2002. The cooking apparatus 2000 of FIG. 20 is a grill (e.g., a charcoal-fueled grill, a gas-fueled grill, a pellet-fueled grill, etc.) The modular grate system 2002 of FIG. 20 includes an example central grate 2004 circumscribed and/or bounded by one or more example peripheral grates 2006. In the illustrated example of FIG. 20, the central grate 2004 of the modular grate system 2002 has a circular profile. In other examples, the central grate 2004 of the modular grate system 2002 can have a non-circular profile. For example, the central grate 2004 of the modular grate system 2002 can have an elliptical profile, a triangular profile, a rectangular profile, a pentagonal profile, a hexagonal profile, etc.

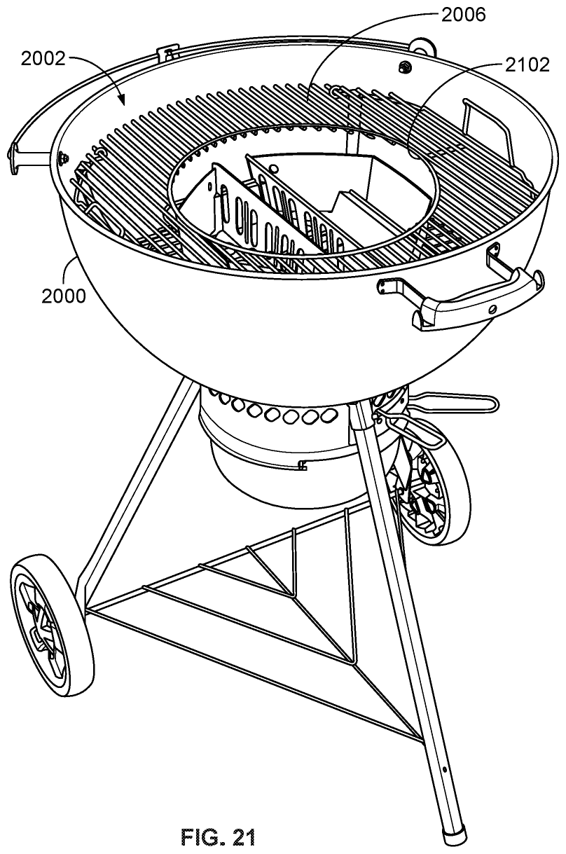

The modular grate system 2002 of FIG. 20 is configured such that the central grate 2004 is removably positioned, seated, and/or docked on the peripheral grate(s) 2006. FIG. 21 is a perspective view of the cooking apparatus of FIG. 20 with the central grate 2004 of the modular grate system 2002 of FIG. 20 removed. Removal of the central grate 2004 from the peripheral grate(s) 2006 results in an example central opening 2102 of the peripheral grate(s) 2006 being exposed. The central opening 2102 is configured to be selectively filled and/or selectively covered by various cooking accessories (e.g., a pizza stone, a sear grate, a wok, etc.), each of which is configured to be removably positioned, seated, and/or docked on the peripheral grate(s) 2006.

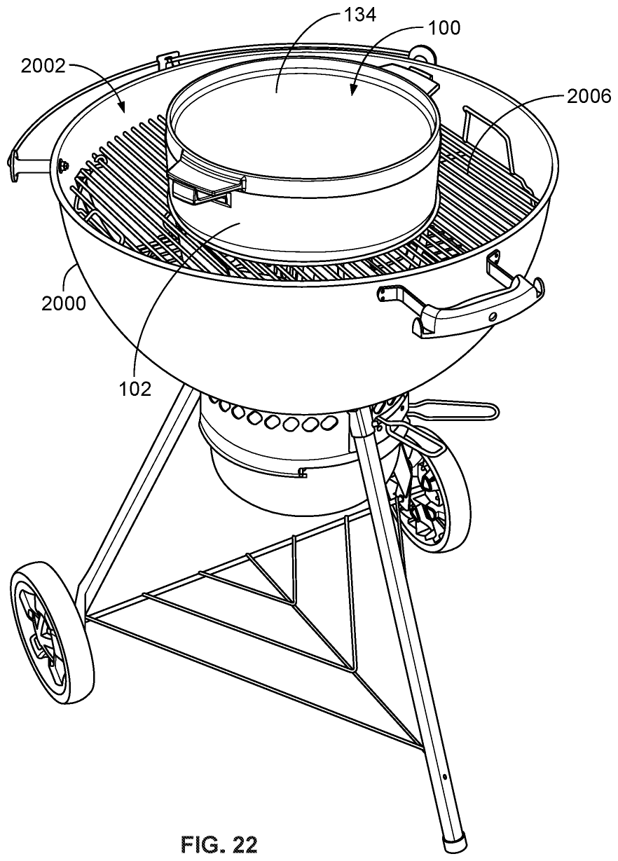

The Dutch oven 100 of FIGS. 1-6 is configured to be used is connection with the modular grate system 2002 of FIGS. 20 and 21, and vice-versa. For example, FIG. 22 is a perspective view of the Dutch oven 100 of FIGS. 1-6 docked in the central opening 2102 of the modular grate system 2002 of FIGS. 20 and 21. In the illustrated example of FIG. 22, the central grate 2004 of the modular grate system 2002 has been removed from the peripheral grate(s) 2006 of the modular grate system 2002. The central opening 2102 that would otherwise be exposed in response to the removal of the central grate 2004 is covered by the pot 102 of the Dutch oven 100, with the base 104 of the pot 102 of the Dutch oven 100 contacting the peripheral grate(s) 2006. The feet 132 of the pot 102 of the Dutch oven 100 guide, locate, position, and/or dock the pot 102 relative to the central opening 2102 such that the pot 102 is not slidable (e.g., along the cooking surface(s) of the peripheral grate(s) 2006) relative to the central opening 2102. In the illustrated example of FIG. 22, the Dutch oven 100 is shown in a position whereby the upper surface 138 of the central portion 136 of the lid 134 is usable as a griddle. In other examples, the Dutch oven 100 can alternatively be placed directly on the central grate 2004 and/or the peripheral grate(s) 2006 of the modular grate system 2002 of the cooking apparatus 2000, or alternatively on one or more other grill grate(s) of either the cooking apparatus 2000 or some other cooking apparatus. In such other examples, the feet 132 of the pot 102 of the Dutch oven 100 contact an underlying support surface formed by the grill grate(s) such that the exterior surface 106 of the base 104 of the pot 102 is raised above and/or off of the underlying support surface when the pot 102 of the Dutch oven 100 is positioned thereon.

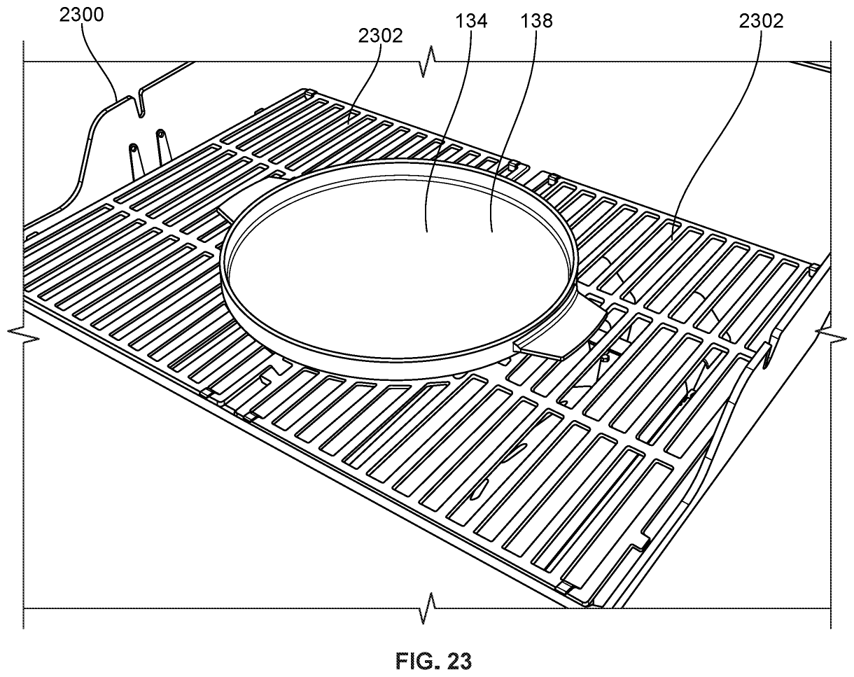

As another example, FIG. 23 is a perspective view of the lid 134 of the Dutch oven 100 of FIGS. 1-6 and 13-19 positioned directly on example grates 2302 of an example cooking apparatus 2300. The cooking apparatus 2300 of FIG. 23 is a grill (e.g., a charcoal-fueled grill, a gas-fueled grill, a pellet-fueled grill, etc.). In the illustrated example of FIG. 23, the second lip 616 of the lid 134 of the Dutch oven 100 contacts the grates 2302. The lid 134 of the Dutch oven 100 is shown in a position whereby the upper surface 138 of the central portion 136 of the lid 134 is usable as a griddle. In other examples, the lid 134 of the Dutch oven 100 can alternatively be placed directly on the central grate 2004 and/or the peripheral grate(s) 2006 of the modular grate system 2002 of the cooking apparatus 2000 of FIG. 20, or alternatively on one or more other grill grate(s) of either the cooking apparatus 2000 or some other cooking apparatus, with the upper surface 138 of the central portion 136 of the lid 134 being oriented as shown in FIG. 23 and accordingly being usable as a griddle.

From the foregoing, it will be appreciated that example Dutch ovens disclosed herein include lids having integral griddles. In some examples, Dutch ovens disclosed herein include a pot having a rim, and further include a lid configured to be seated on the rim of the pot. In some examples, the lid includes a central portion having an upper surface forming a griddle, wherein the upper surface of the central portion is oriented away from the pot when the lid is seated on the rim of the pot. In such examples, the upper surface of the central portion of the lid is advantageously usable as a griddle not only when the lid is seated on the rim of the pot, but also when the lid is removed from the pot and positioned directly on and/or over an underlying heat source (e.g., when the lid is positioned directly on a grate of a grill without being seated on the rim of the pot. In such examples, the lid is advantageously configured to have only a single orientation of use regardless of whether the lid is simply being used to cover the pot or whether the lid is additionally or alternatively being used as a griddle, either with or without the pot.

In some examples, a Dutch oven is disclosed. In some disclosed examples, the Dutch oven comprises a pot and a lid. In some disclosed examples, the pot has a rim. In some disclosed examples, the lid is configured to be seated on the rim of the pot. In some disclosed examples, the lid includes a central portion having an upper surface forming a griddle. In some disclosed examples, the upper surface of the central portion is oriented away from the pot when the lid is seated on the rim of the pot.

In some disclosed examples, the upper surface of the central portion is flat.

In some disclosed examples, the upper surface of the central portion does not include any upwardly-extending protrusions.

In some disclosed examples, the central portion has a lower surface located opposite the upper surface of the central portion. In some disclosed examples, the lower surface of the central portion includes downwardly-extending protrusions formed as concave dimples.

In some disclosed examples, the lid includes a first lip coupled to and extending upwardly from the central portion. In some disclosed examples, the first lip provides a peripheral boundary to the upper surface of the central portion. In some disclosed examples, the lid further includes a second lip coupled to and extending downwardly from the central portion. In some disclosed examples, the second lip provides a guide for seating the lid on the rim of the pot. In some disclosed examples, the second lip is circumscribed by the rim of the pot when the lid is seated on the rim of the pot.

In some disclosed examples, the first lip is configured to prevent the lid from being seated on the rim of the pot in an upside-down orientation.

In some disclosed examples, the lid includes handles coupled to and extending outwardly from the first lip of the lid. In some disclosed examples, each of the handles of the lid includes an outer edge.

In some disclosed examples, the pot includes handles coupled to a sidewall of the pot. In some disclosed examples, each of the handles of the pot includes a first flange coupled to and extending outwardly from the sidewall and a second flange coupled to and extending upwardly from the first flange.

In some disclosed examples, the second flanges of the handles of the pot collectively circumscribe the outer edges of the handles of the lid when the lid is seated on the rim of the pot.

In some disclosed examples, the pot includes feet coupled to and extending downwardly from a base of the pot.

In some disclosed examples, the pot is configured to be docked on a modular grate system.

In some disclosed examples, the feet are configured to be located within a central opening of the modular grate system when the pot is docked on the modular grate system.

In some disclosed examples, the lid is further configured to be removed from the pot and positioned directly on the modular grate system with the upper surface of the central portion oriented away from the modular grate system.

In some examples, a lid for a pot of a Dutch oven is disclosed. In some disclosed examples, the lid comprises a central portion having an upper surface forming a griddle. In some disclosed examples, the upper surface of the central portion is oriented away from the pot when the lid is seated on a rim of the pot.

In some disclosed examples, the upper surface of the central portion is flat.

In some disclosed examples, the upper surface of the central portion does not include any upwardly-extending protrusions.

In some disclosed examples, the central portion has a lower surface located opposite the upper surface of the central portion. In some disclosed examples, the lower surface of the central portion includes downwardly-extending protrusions formed as concave dimples.

In some disclosed examples, the lid further comprises a first lip coupled to and extending upwardly from the central portion. In some disclosed examples, the first lip provides a peripheral boundary to the upper surface of the central portion. In some disclosed examples, the lid further comprises a second lip coupled to and extending downwardly from the central portion. In some disclosed examples, the second lip provides a guide for seating the lid on the rim of the pot. In some disclosed examples, the second lip is circumscribed by the rim of the pot when the lid is seated on the rim of the pot.

In some disclosed examples, the first lip is configured to prevent the lid from being seated on the rim of the pot in an upside-down orientation.

In some disclosed examples, the lid further comprises handles coupled to and extending outwardly from the first lip of the lid.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A Dutch oven, comprising:
a pot having a rim; and
a lid configured to be seated on the rim of the pot, the lid including a central portion having an upper surface forming a griddle, the upper surface of the central portion being oriented away from the pot when the lid is seated on the rim of the pot.

2. The Dutch oven of claim 1, wherein the upper surface of the central portion is flat.

3. The Dutch oven of claim 1, wherein the upper surface of the central portion does not include any upwardly-extending protrusions.

4. The Dutch oven of claim 1, wherein central portion has a lower surface located opposite the upper surface of the central portion, the lower surface of the central portion including downwardly-extending protrusions formed as concave dimples.

5. The Dutch oven of claim 1, wherein the lid includes:
a first lip coupled to and extending upwardly from the central portion, the first lip providing a peripheral boundary to the upper surface of the central portion; and
a second lip coupled to and extending downwardly from the central portion, the second lip providing a guide for seating the lid on the rim of the pot, the second lip being circumscribed by the rim of the pot when the lid is seated on the rim of the pot.

6. The Dutch oven of claim 5, wherein the first lip is configured to prevent the lid from being seated on the rim of the pot in an upside-down orientation.

7. The Dutch oven of claim 5, wherein the lid includes handles coupled to and extending outwardly from the first lip of the lid, each of the handles of the lid including an outer edge.

8. The Dutch oven of claim 7, wherein the pot includes handles coupled to a sidewall of the pot, each of the handles of the pot including a first flange coupled to and extending outwardly from the sidewall and a second flange coupled to and extending upwardly from the first flange.

9. The Dutch oven of claim 8, wherein the second flanges of the handles of the pot collectively circumscribe the outer edges of the handles of the lid when the lid is seated on the rim of the pot.

10. The Dutch oven of claim 1, wherein the pot includes feet coupled to and extending downwardly from a base of the pot.

11. The Dutch oven of claim 10, wherein the pot is configured to be docked on a modular grate system.

12. The Dutch oven of claim 11, wherein the feet are configured to be located within a central opening of the modular grate system when the pot is docked on the modular grate system.

13. The Dutch oven of claim 11, wherein the lid is further configured to be removed from the pot and positioned directly on the modular grate system with the upper surface of the central portion oriented away from the modular grate system.

14. A lid for a pot of a Dutch oven, the lid comprising:
a central portion having an upper surface forming a griddle, the upper surface of the central portion being oriented away from the pot when the lid is seated on a rim of the pot.

15. The lid of claim 14, wherein the upper surface of the central portion is flat.

16. The lid of claim 14, wherein the upper surface of the central portion does not include any upwardly-extending protrusions.

17. The lid of claim 14, wherein the central portion has a lower surface located opposite the upper surface of the central portion, the lower surface of the central portion including downwardly-extending protrusions formed as concave dimples.

18. The lid of claim 14, further comprising:
a first lip coupled to and extending upwardly from the central portion, the first lip providing a peripheral boundary to the upper surface of the central portion; and
a second lip coupled to and extending downwardly from the central portion, the second lip providing a guide for seating the lid on the rim of the pot, the second lip being circumscribed by the rim of the pot when the lid is seated on the rim of the pot.

19. The lid of claim 18, wherein the first lip is configured to prevent the lid from being seated on the rim of the pot in an upside-down orientation.

20. The lid of claim 18, further comprising handles coupled to and extending outwardly from the first lip of the lid.
